(19) United States
(12) Patent Application Publication
(10) Pub. No.: US 2007/0236423 A1
(43) Pub. Date: Oct. 11, 2007

(54) AMOLED DISPLAY DEVICE

(75) Inventors: Yu-Wen Chiou, Tainan County (TW); Lin-Kai Bu, Tainan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: HIMAX TECHNOLOGIES LIMITED, Tainan County (TW)

(21) Appl. No.: 11/685,229

(22) Filed: Mar. 13, 2007

(30) Foreign Application Priority Data
Apr. 10, 2006 (TW) 95112733

(51) Int. Cl. G09G 3/30

(52) U.S. Cl. 345/76

(57) ABSTRACT

An active matrix organic light emitting diode (AMOLED) display device including a panel, a master source driver and at least one slave source driver is provided. The panel has a group of master column pixels and at least one group of slave column pixels. The master source driver receives a reference current and duplicates the reference current to output a master current for driving the group of master column pixels. The at least one slave source driver, coupled to the master source driver or a preceding slave source driver, duplicates the master current or a slave current outputted by the preceding slave source driver as a new slave current and outputs the new slave current for driving the at least one group of slave column pixels.

This application claims the benefit of Taiwan application Ser. No. 95112733, filed Apr. 10, 2006, the subject matter of which is incorporated herein by reference.

### BACKGROUND OF THE INVENTION

1. Field of the Invention

The invention relates in general to an active matrix organic light emitting diode (AMOLED) display device, and more particularly to an AMOLED display device with uniformed current.

2. Description of the Related Art

It is essential for a current driven active light emitting diode that the source driver must be able to provide a stable current source. That is, the currents, corresponding to the same grey level value, provided by all the channels of the source drivers must be very close and the reverse in grey level value is not permitted between neighboring channels of the source drivers. When the same source driver is used, the above object can be achieved by the device matching or improving circuit configuration. However, when many source drivers are used to provide the current sources at the same time, device matching is not applicable among many source drivers.

Referring to FIG. 1, a perspective of a conventional AMOLED display device is shown. In the AMOLED display device 10, the panel 12 has many column pixels, and the source drivers 141˜14n respectively receive a reference current Iref to drive corresponding column pixels. Due to the manufacturing factors, the currents received by the source driver 141˜14n to drive the corresponding column pixels may deviate from the reference current Iref by ΔI1˜ΔIn. For example, the current I1 received by the source driver 141 to drive the corresponding column pixels should be Iref, but is now equal to I1=Iref+ΔI1. As the currents vary largely, the grey level values of neighboring source drivers may reverse. Consequently, despite the panel 12 has excellent pixel circuit compensation, the AMOLED display device 10 still may display an erroneous frame because the currents provided by the source driver 141˜14n are not uniformed.

### SUMMARY OF THE INVENTION

The invention is directed to an active matrix organic light emitting diode (AMOLED) display device. According to the AMOLED display device of the invention, currents are connected in parallel such that the difference between the currents outputted by different source drivers is reduced, hence achieving uniformed currents.

According to a first aspect of the present invention, an AMOLED display device including a panel, a master source driver and at least one slave source driver is provided. The panel has a group of master column pixels and at least one group of slave column pixels. The master source driver receives a reference current and duplicates the reference current to output a master current for driving the group of master column pixels. The at least one slave source driver, coupled to the master source driver or a preceding slave source driver, duplicates the master current or a slave current outputted by the preceding slave source driver to output a new slave current for driving the at least one group of slave column pixels.

According to a second aspect of the present invention, an AMOLED display device including a panel, a master source driver and at least one slave source driver is provided. The panel has a group of master column pixels and at least one group of slave column pixels. The master source driver receives a reference current and duplicates the reference current as a master current and at least one slave current to output the master current for driving the group of master column pixels. The at least one slave source driver, coupled to the master source driver or a preceding slave source driver, receives one of the at least one slave current and outputs a new slave current for driving the second column pixels.

According to a third aspect of the present invention, an AMOLED display device including a panel, a current source circuit and a plurality of source drivers is provided. The panel has many groups of column pixels. The current source circuit receives a reference current and duplicates the reference current to output a master current. Each source driver, coupled to current source circuit, duplicates the master current as a plurality of slave currents and outputs the slave currents for driving each group of column pixels.

According to a fourth aspect of the present invention, an AMOLED display device including a panel, a master source driver and at least one slave source driver is provided. The panel having many groups of column pixels includes a group of master column pixels and at least one group of slave column pixels. The master source driver receives a reference current and duplicates the reference current to output a master current, and refers to both the master current and a first calibration current transmitted back by a neighboring slave source driver to output a master data current for driving the group of master column pixels. The master data current is an average current of the master current and first calibration current. Each slave source driver, coupled to the master source driver or a preceding slave source driver, duplicates the master current or a slave current outputted by the preceding slave source driver as a new slave current, and refers to both the new slave current and a second calibration current transmitted back by a subsequent slave source driver to output at least one slave data current for driving each group of slave column pixels. The at least one slave data current is an average current of the new slave current and the second calibration current transmitted back by the subsequent source driver.

The invention will become apparent from the following detailed description of the preferred but non-limiting embodiments. The following description is made with reference to the accompanying drawings.

### BRIEF DESCRIPTION OF THE DRAWINGS

FIG. 1 (PriorArt) is a perspective of a conventional AMOLED display device;

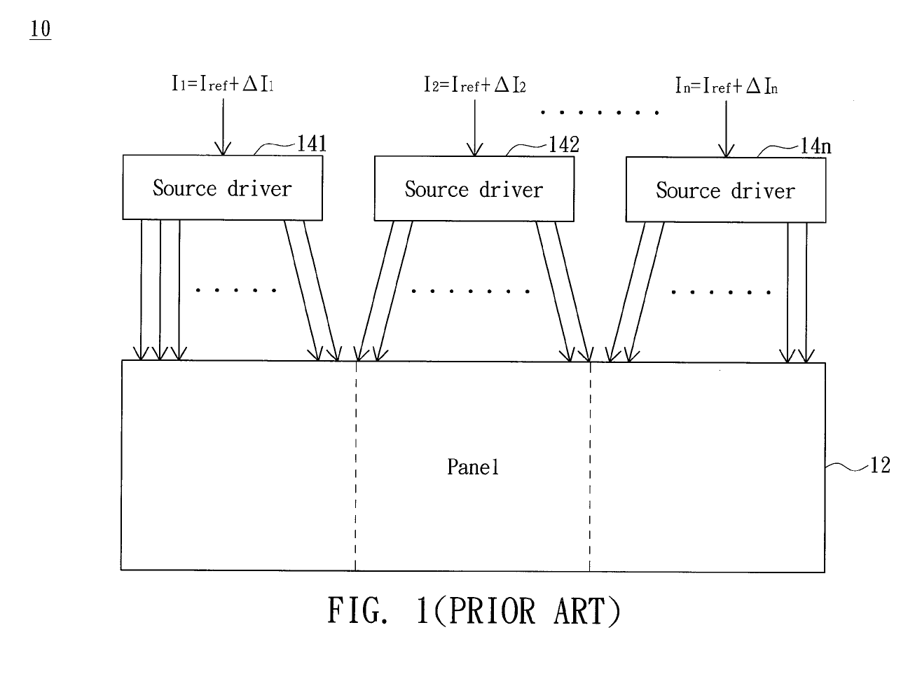

FIG. 2 is a perspective of an AMOLED display device according to a first embodiment of the invention;

FIG. 3 is a perspective of an AMOLED display device according to a second embodiment of the invention;

FIG. 4 is a perspective of an AMOLED display device according to a third embodiment of the invention; and

FIG. 5 is a perspective of an AMOLED display device according to a fourth embodiment of the invention.

### DETAILED DESCRIPTION OF THE INVENTION

According to the AMOLED display device of the invention, currents are connected in parallel such that the difference between the currents outputted by different source drivers is reduced, hence achieving uniformed currents. The invention is exemplified by an AMOLED display device having three source drivers, but is not limited thereto. The AMOLED display device having more source drivers is still within the scope of protection of the invention.

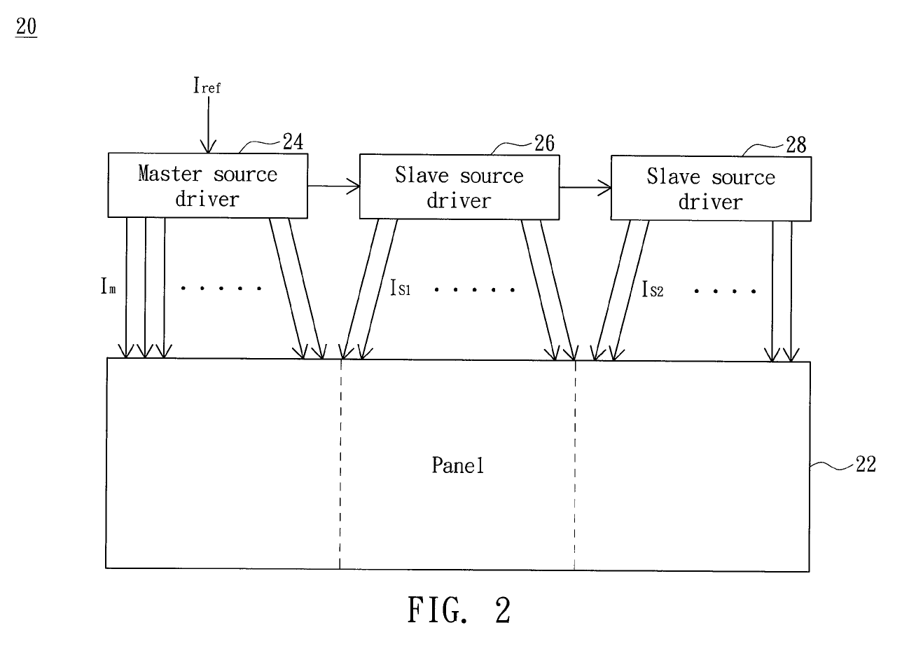

Referring to FIG. 2, a perspective of an AMOLED display device according to a first embodiment of the invention is shown. As indicated in the diagram, in the AMOLED display device 20, the panel 22 has a first group of column pixels, a second group of column pixels and a third group of column pixels driven by a master source driver 24, a slave source driver 26 and a slave source driver 28 respectively. The master source driver 24 receives a reference current Iref and duplicates the reference current Iref to output a master current Im for driving the first group of column pixels. The slave source driver 26, coupled to the master source driver 24, duplicates the master current Im as a first slave current Is1 and outputs the first slave current Is1 for driving the second group of column pixels. The slave source driver 28, coupled to slave source driver 26, duplicates the first slave current Is1 as a second slave current Is2 and outputs the second slave current Is2 for driving the third group of column pixels.

All the currents in the AMOLED display device 20 are transmitted via a printed circuit board (not shown in the diagram) or a glass substrate (not shown in the diagram) inside the AMOLED display device 20.

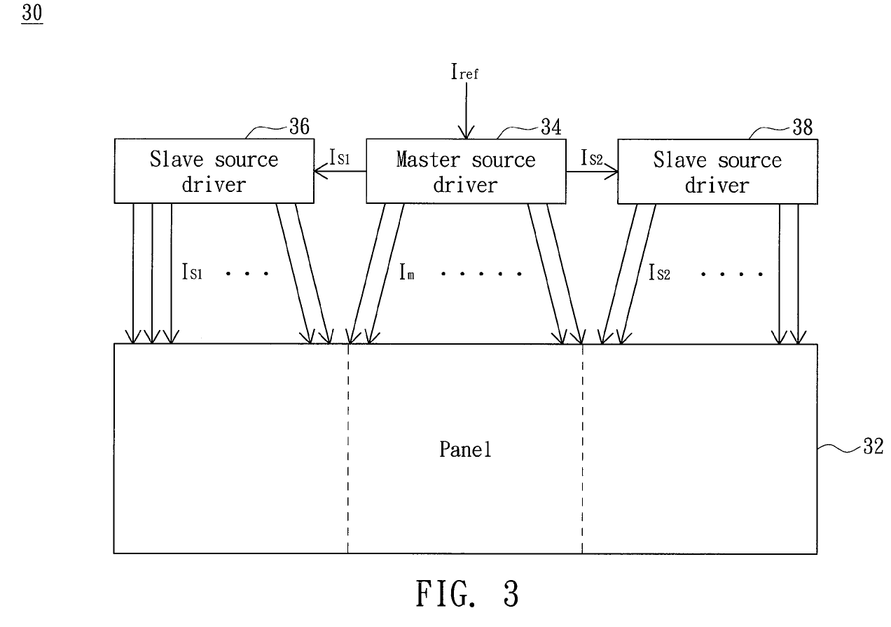

Referring to FIG. 3, a perspective of an AMOLED display device according to a second embodiment of the invention is shown. As indicated in the diagram, in the AMOLED display device 30, the panel 32 has a first group of column pixels, a second group of column pixels and a third group of column pixels driven by a master source driver 34, a slave source driver 36 and a slave source driver 38 respectively. The master source driver 34 receives a reference current Iref and duplicates the reference current Iref as a master current Im, a first slave current Is1 and a second slave current Is2 and outputs the master current Im for driving the first group of column pixels. The slave source driver 36, coupled to the master source driver 34, receives and outputs the first slave current Is1 for driving the second group of column pixels. The slave source driver 38, coupled to the master source driver 34, receives and outputs the second slave current Is2 for driving the third group of column pixels.

All the currents in the AMOLED display device 30 are transmitted via a printed circuit board (not shown in the diagram) or a glass substrate (not shown in the diagram) inside the AMOLED display device 30.

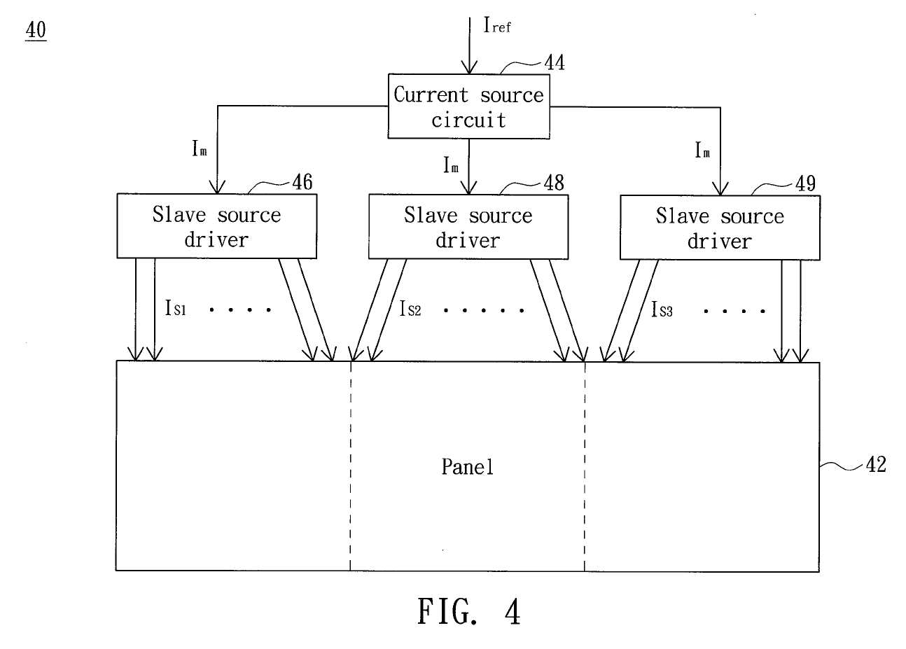

Referring to FIG. 4, a perspective of an AMOLED display device according to a third embodiment of the invention is shown. As indicated in the diagram, in the AMOLED display device 40, the panel 42 has a first group of column pixels, a second group of column pixels and a third group of column pixels driven by a slave source driver 46, a slave source driver 48 and a slave source driver 49 respectively. The current source circuit 44 of the AMOLED display device 40 receives a reference current Iref and duplicates the reference current Iref to output many identical master currents Im. The slave source driver 46, coupled to the current source circuit 44, duplicates a master current Im as a first slave current Is1 and outputs the first slave current Is1 for driving the first group of column pixels. The slave source driver 48 and the slave source driver 49, both coupled to the current source circuit 44, duplicate the other master currents Im as a second slave current Is1 and a third slave current Is2 and output the first slave current Is1 and the third slave current Is2 for driving the second group and the third group of column pixels.

All the currents in the AMOLED display device 40 are transmitted via a printed circuit board (not shown in the diagram) or a glass substrate (not shown in the diagram) inside the AMOLED display device 40.

Unlike the conventional practice in which the source driver individually receives a reference current Iref hence resulting in deviation, the current outputted by each source driver of the AMOLED display device disclosed in the above embodiments of the invention refers to the same reference current Iref and duplicates many identical master currents Im. Consequently, the difference between currents is very small, and the uniformity in the currents of the overall AMOLED display device is improved.

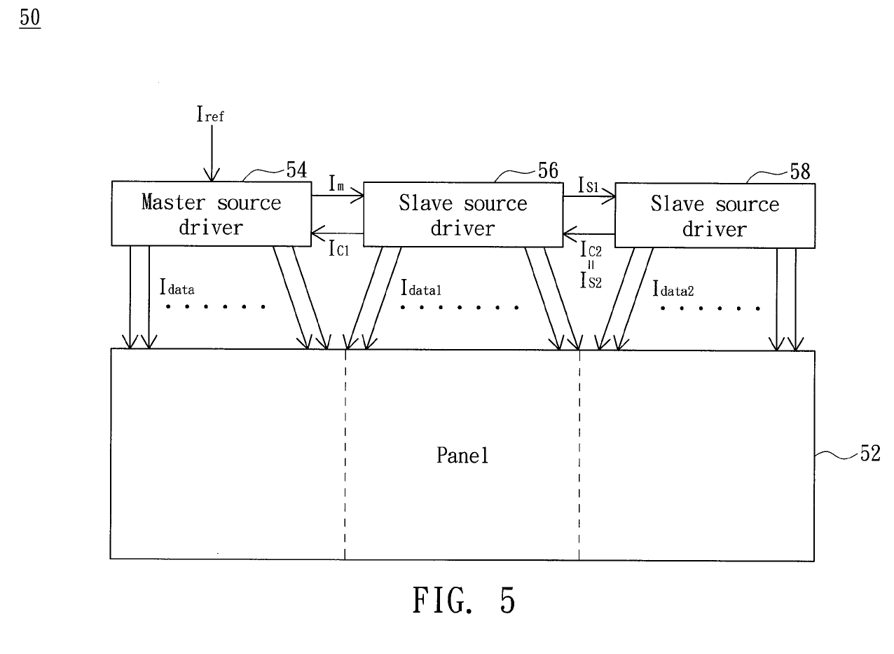

In order to further improve the uniformity in the currents of the overall AMOLED display device, a calibration mechanism can be introduced to the AMOLED display device. Referring to FIG. 5, a perspective of an AMOLED display device according to a fourth embodiment of the invention is shown. As indicated in the diagram, in the AMOLED display device 50, the panel 52 has a first group of column pixels, a second group of column pixels and a third group of column pixels driven by a master source driver 54, a slave source driver 56 and a slave source driver 58 respectively.

The master source driver 54 receives a reference current Iref and duplicates the reference current Iref to output a master current Im, and receives a first calibration current Ic1 transmitted back by the slave source driver 56 to output a master data current Idata1 for driving the first group of column pixels. The master data current Idata1 is an average current of the master current Im and the first calibration current Ic1.

The slave source driver 56, coupled to the master source driver 54, duplicates the master current Im as a first slave current Is1, and receives a second calibration current Ic2 transmitted back by the slave source driver 58 to output a first slave data current Idata1 for driving the second group of column pixels. The first slave data current Idata1 is an average current of of the first slave current Is1 and the second calibration current Ic2.

The slave source driver 58, coupled to slave source driver 56, duplicates the first slave current Is1 and a second slave current Is2 and transmits the second calibration current Ic2 to the master source driver 54 according to the second slave current. The second slave current Is2 is substantially equal to the second calibration current Ic2. The slave source driver 58 outputs a second slave data current Idata2 for driving many third column pixels. The second slave data current Idat2 is an average current of the second slave current Is2 and the second calibration current Ic2. That is, the second slave data current Idata2 is substantially equal to the second slave current Is2.

All the currents in the AMOLED display device 50 are transmitted via a printed circuit board (not shown in the diagram) or a glass substrate (not shown in the diagram) inside the AMOLED display device 50. As each source driver has a calibration current, the difference between the currents outputted by each source driver is further reduced, and the uniformity in the currents of the overall AMOLED display device is further improved.

According to the conventional practice, the source driver individually receives a reference current Iref hence causing deviation. According to the AMOLED display device disclosed in the above embodiments of the invention, the currents are connected in parallel and the same reference current is used, such that the difference between the currents outputted different source drivers is reduced, and the uniformity in the currents of the overall AMOLED display device is achieved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An active matrix organic light emitting diode (AMOLED) display device, comprising:
a panel having a group of master column pixels and at least one group of slave column pixels;
a master source driver used for receiving a reference current and duplicating the reference current to output a master current for driving the group of master column pixels; and
at least one slave source driver coupled to the master source driver or a preceding slave source driver, wherein the at least one slave source driver duplicates the master current or a slave current outputted by the preceding slave source driver to output a new slave current for driving the at least one group of slave column pixels.

2. The AMOLED display device according to claim 1, wherein the at least one slave source driver is serially connected together and is serially connected to the master source driver.

3. The AMOLED display device according to claim 1, wherein the currents are transmitted through a printed circuit board or a glass substrate.

4. An AMOLED display device, comprising:
a panel having a group of master column pixels and at least one group of slave column pixels;
a master source driver used for receiving a reference current and duplicating the reference current as a master current and at least one slave current, and further outputting the master current for driving the group of master column pixels; and
at least one slave source driver coupled to the master source driver or a preceding slave source driver, wherein the at least one slave source driver receives one of the at least one slave current to output a new slave current for driving the at least one group of slave column pixels.

5. The AMOLED display device according to claim 4, wherein the at least one slave source driver is serially connected together and is serially connected to the master source driver.

6. The AMOLED display device according to claim 4, wherein the currents are transmitted through a printed circuit board or a glass substrate.

7. An AMOLED display device, comprising:
a panel having a plurality of groups of column pixels;
a current source circuit used for receiving a reference current and duplicating the reference current to output a master current; and
a plurality of source drivers coupled to the current source circuit, wherein the source drivers duplicate the master current as a plurality of slave currents and output the slave currents for driving the groups of column pixels.

8. The AMOLED display device according to claim 7, wherein the currents are transmitted through a printed circuit board or a glass substrate.

9. An AMOLED display device, comprising:
a panel having a group of master column pixels and at least one group of slave column pixels;
a master source driver used for receiving a reference current and duplicating the reference current to output a master current, wherein the master source driver refers to both the master current and a first calibration current transmitted back by a neighboring slave source driver to output a master data current for driving the group of master column pixels, the master data current is an average current of the master current and the first calibration current;
at least one slave source driver coupled to the master source driver or a preceding slave source driver, wherein the at least one slave source driver duplicates the master current or a slave current outputted by the preceding slave source driver as at least one new slave current, and refers to both the at least one new slave current and a second calibration current transmitted back by a subsequent slave source driver to output at least one slave data current for driving the at least one group of slave column pixels, the at least one slave data current is an average current of the at least one new slave current and the second calibration current.

10. The AMOLED display device according to claim 9, wherein the at least one slave source driver is serially connected together and is serially connected to the master source driver.

11. The AMOLED display device according to claim 9, wherein the currents are transmitted through a printed circuit board or a glass substrate.
